(19) United States
(12) Patent Application Publication
(10) Pub. No.: US 2012/0221197 A1
(43) Pub. Date: Aug. 30, 2012

(54) ELECTRIC VEHICLE DRIVE SYSTEM

(75) Inventors: Hideki Hisada, Kawasaki (JP); Ryuta Horie, Anjo (JP); Akira Suzuki, Oba (JP)

(73) Assignee: AISIN AW CO., LTD., Anjo-shi (JP)

(21) Appl. No.: 13/365,657

(22) Filed: Feb. 3, 2012

(30) Foreign Application Priority Data
Feb. 28, 2011 (JP) 2011-042100

(51) Int. Cl. B60L 15/20; B60H 1/32; B60K 17/02; F16H 37/06

(52) U.S. Cl. 701/36; 74/665 F

(57) ABSTRACT

An electric vehicle drive system including an output member that is drive-coupled to a wheel, and a compressor connection member that is coupled to a compressor for an air conditioner. A drive power to be transmitted to the output member and the compressor connection member is generated by a rotating electric machine. The electric vehicle drive system further includes a wheel-driving rotating electric machine that has a rotor shaft drive-coupled to the output member and an air-conditioner rotating electric machine that has a rotor shaft drive-coupled to the compressor connection member through a second clutch. The rotor shaft of the air-conditioner rotating electric machine is drive-coupled to the rotor shaft of the wheel-driving rotating electric machine through a first clutch.

### INCORPORATION BY REFERENCE

The disclosure of Japanese Patent Application No. 2011-042100 filed on Feb. 28, 2011 including the specification, drawings and abstract is incorporated herein by reference in its entirety.

### BACKGROUND OF THE INVENTION

The present invention relates to an electric vehicle drive system including an output member that is drive-coupled to a wheel; and a compressor connection member that is coupled to a compressor for an air conditioner, wherein a drive power to be transmitted to the output member and the compressor connection member is generated by a rotating electric machine.

### DESCRIPTION OF THE RELATED ART

Art such as that disclosed in Japanese Patent Application Publication No. JP-A-2010-178403 below relates to the vehicle drive control system described above. According to the art of JP-A-2010-178403, a rotor shaft of a rotating electric machine for an air conditioner is drive-coupled to an output member in addition to a compressor connection member, whereby the drive power of the air-conditioner rotating electric machine can assist a rotating electric machine for driving a wheel to drive a vehicle.

However, according to the art of JP-A-2010-178403, a rotor shaft of the wheel-driving rotating electric machine is drive-coupled to a ring gear of a planetary gear device; the rotor shaft of the air-conditioner rotating electric machine and the compressor connection member are drive-coupled to a sun gear of the planetary gear device; and the output member is drive-coupled to a carrier of the planetary gear device. Therefore, the rotor shaft of the wheel-driving rotating electric machine, the rotor shaft of the air-conditioner rotating electric machine, and the output member are always drive-coupled to each other through the planetary gear device. As a consequence, changes in the rotational speeds of the wheel-driving rotating electric machine and the output member affect the rotational speed of the air-conditioner rotating electric machine.

Thus, according to the art of JP-A-2010-178403, it is necessary to consider the practical range of rotational speeds of the wheel-driving rotating electric machine and the output member in order to set the usable range of rotational speeds of the air-conditioner rotating electric machine. However, a rotating electric machine with the best usable range of rotational speeds for driving the compressor and the vehicle cannot always be used as the air-conditioner rotating electric machine.

In addition, when changing the rotational speed of the wheel-driving rotating electric machine, that rotational speed must not exceed the usable range of rotational speeds of the air-conditioner rotating electric machine. As a consequence, it may not be possible to operate the wheel-driving rotating electric machine at the best rotational speed or obtain sufficient drive power.

According to the art of JP-A-2010-178403, the rotor shaft of the air-conditioner rotating electric machine is drive-coupled to the compressor connection member. Therefore, the drive power of the air-conditioner rotating electric machine is used not only for driving the vehicle, but also for driving the compressor. Thus, the drive power from the air-conditioner rotating electric machine that is used to drive the compressor correspondingly reduces the drive power from the air-conditioner rotating electric machine that is used to assist the wheel-driving rotating electric machine.

### SUMMARY OF THE INVENTION

In view of the foregoing, for a configuration in which a vehicle is driven by the drive power of an air-conditioner rotating electric machine, an electric vehicle drive system is required that is capable of using, as the air-conditioner rotating electric machine, a rotating electric machine with the best usable range of rotational speeds to drive a compressor and the vehicle, and also capable of increasing the energy efficiency of the vehicle by using the drive power of the air-conditioner rotating electric machine to drive the vehicle.

An electric vehicle drive system according to a first aspect of the present invention includes an output member that is drive-coupled to a wheel, and a compressor connection member that is coupled to a compressor for an air conditioner, wherein a drive power to be transmitted to the output member and the compressor connection member is generated by a rotating electric machine. The electric vehicle drive system further includes: a wheel-driving rotating electric machine that has a rotor shaft drive-coupled to the output member; and an air-conditioner rotating electric machine that has a rotor shaft drive-coupled to the compressor connection member through a second clutch, wherein the rotor shaft of the air-conditioner rotating electric machine is drive-coupled to the rotor shaft of the wheel-driving rotating electric machine through a first clutch.

Note that in the present application, the “rotating electric machine” is used as an idea that includes any one of a motor (electric motor), a generator (electric generator), and a motor/generator that carries out both the functions of a motor and a generator as necessary.

In addition, “drive-coupled” in the present application refers to a state in which two rotation elements are connected capable of transmitting a drive power, and is used as an idea that includes a state in which the two rotation elements are coupled so as to rotate together, or a state in which the two rotation elements are coupled capable of transmitting a drive power through one, two, or more transmission members. Such transmission members include various types of members that transmit rotation at the same speed or a changed speed, and include a shaft, a gear mechanism, a belt, and a chain, for example. In addition, such transmission members may include an engagement element that selectively transmits a rotation and a drive power, such as a friction clutch and a dog clutch, for example.

According to the first aspect of the present invention, engaging the first clutch drive-couples the rotor shaft of the air-conditioner rotating electric machine to the rotor shaft of the wheel-driving rotating electric machine that is drive-coupled to the output member. By thus engaging the first clutch, the drive power of the air-conditioner rotating electric machine can assist the drive power of the wheel-driving rotating electric machine and enable driving of the vehicle.

Also, according to the first aspect of the present invention, engaging the first clutch and disengaging the second clutch achieves a state in which the drive power of the air-conditioner rotating electric machine is not used to drive the compressor, and only used to drive the vehicle. Thus, in cases where the vehicle has insufficient drive power based on the wheel-driving rotating electric machine alone, the drive power of the air-conditioner rotating electric machine can be reliably used for driving the vehicle.

Accordingly, a maximum output torque of the wheel-driving rotating electric machine can be set lower, which can also reduce the size and cost of the wheel-driving rotating electric machine.

According to the first aspect of the present invention, if the rotational speed of the output member exceeds the usable range of rotational speeds of the air-conditioner rotating electric machine, disengaging the first clutch ensures that the rotational speed of the air-conditioner rotating electric machine does not exceed the usable range of rotational speeds thereof. It is thus possible to prevent a failure caused by excessive rotation of the air-conditioner rotating electric machine. There is also no need to match the usable range of rotational speeds of the air-conditioner rotating electric machine with the practical range of rotational speeds of the output member, and the upper limit of the usable range of rotational speeds thereof can be lowered. Thus, a rotating electric machine with the best usable range of rotational speeds for driving the compressor and the vehicle can be used as the air-conditioner rotating electric machine, which can also improve the vehicle power performance and reduce the cost of the rotating electric machine.

According to a second aspect of the present invention, the drive power to be transmitted to the output member and the compressor connection member may be generated by only the wheel-driving rotating electric machine and the air-conditioner rotating electric machine.

According to the second aspect of the present invention, in the electric vehicle drive system that uses a rotating electric machine as the drive power sources of the vehicle and the compressor, as described above, the drive power of the air-conditioner rotating electric machine and the wheel-driving rotating electric machine can be effectively used.

According to a third aspect of the present invention, a maximum output of the air-conditioner rotating electric machine may be smaller than a maximum output of the wheel-driving rotating electric machine.

According to the third aspect of the present invention, the wheel-driving rotating electric machine with a large maximum output is mainly used as the drive power source of the vehicle, and the air-conditioner rotating electric machine with a small maximum output can be used to assist the wheel-driving rotating electric machine by engaging the first clutch.

According to a fourth aspect of the present invention, the rotor shaft of the air-conditioner rotating electric machine may be drive-coupled to the rotor shaft of the wheel-driving rotating electric machine through a speed reducer.

According to the fourth aspect of the present invention, by reducing the rotational speed of the air-conditioner rotating electric machine using the speed reducer and transmitting the reduced rotational speed to the output member, the torque of the air-conditioner rotating electric machine can be increased and transmitted to the output member. It is thus possible to secure a torque that can be transmitted to the wheel and set a lower maximum output torque of the wheel-driving rotating electric machine, which can also reduce the size and cost of the wheel-driving rotating electric machine.

According to a fifth aspect of the present invention, the rotor shaft of the wheel-driving rotating electric machine may be drive-coupled to the output member through a third clutch.

According to the fifth aspect of the present invention, if the wheel-driving rotating electric machine cannot output torque, the third clutch can be disengaged to cancel the drive-coupling between the rotor shaft of the wheel-driving rotating electric machine and the output member. It is thus possible to reduce the energy loss caused by rotation of the wheel-driving rotating electric machine. In particular, if the first clutch is engaged and only the drive power of the air-conditioner rotating electric machine drives the vehicle, disengaging the third clutch can reduce the energy loss caused by rotation of the wheel-driving rotating electric machine and improve the efficiency of driving the vehicle using the air-conditioner rotating electric machine.

According to a sixth aspect of the present invention, the rotor shaft of the air-conditioner rotating electric machine may be drive-coupled to the rotor shaft of the wheel-driving rotating electric machine through a transmission with a changeable speed ratio.

According to the sixth aspect of the present invention, the drive power of the air-conditioner rotating electric machine to be transmitted to the output member can be suitably set by changing the speed ratio of the transmission in accordance with the drive power required of the vehicle and the like. For example, if a high torque is required of the vehicle, the speed ratio of the transmission can be set large to increase the amount by which the torque of the air-conditioner rotating electric machine to be transmitted to the output member is amplified. Thus, if the vehicle required torque is high, a torque that corresponds to that required torque can be transmitted to the output member.

As another example, if a low torque is required of the vehicle, the speed ratio of the transmission can be set small to lower the rotational speed of the air-conditioner rotating electric machine with respect to the rotational speed of the output member. It is thus possible to expand the rotational speed area of the output member that can be assisted by the air-conditioner rotating electric machine, and smooth the output torque characteristic of the electric vehicle drive system. In addition, an inexpensive and small rotating electric machine whose usable range of rotational speeds has a relatively low upper limit can be used as the air-conditioner rotating electric machine.

According to a seventh aspect of the present invention, the rotor shaft of the air-conditioner rotating electric machine may be drive-coupled to the output member through the rotor shaft of the wheel-driving rotating electric machine.

According to the seventh aspect of the present invention, the rotor shaft of the wheel-driving rotating electric machine can be effectively used to transmit the drive power of the air-conditioner rotating electric machine to the output member. Thus, the weight and cost of the overall electric vehicle drive system can be reduced.

According to an eighth aspect of the present invention, the electric vehicle drive system may further include a control device that controls the first clutch, the second clutch, the wheel-driving rotating electric machine, and the air-conditioner rotating electric machine. Moreover, regardless of whether a request is made to operate the air conditioner, the control device may set the first clutch to an engaged state and the second clutch to a disengaged state, and output a positive torque to both the wheel-driving rotating electric machine and the air-conditioner rotating electric machine if a vehicle required torque that is a torque required of a vehicle cannot be output by the wheel-driving rotating electric machine alone.

According to the eighth aspect of the present invention, if the wheel-driving rotating electric machine alone cannot output the required torque of the vehicle, regardless of an air conditioner operation request being made, the driving of the compressor by the air-conditioner rotating electric machine is stopped and the drive power of the air-conditioner rotating electric machine is used to drive the vehicle so that the required torque of the vehicle can be output.

If the wheel-driving rotating electric machine alone cannot output the required torque of the vehicle, regardless of no air conditioner operation request being made, the drive power of the air-conditioner rotating electric machine is used to drive the vehicle so that the required torque of the vehicle can be output.

### BRIEF DESCRIPTION OF THE DRAWINGS

FIG. 1 is a skeleton diagram of an electric vehicle drive system according to an embodiment of the present invention;

FIG. 2 is a block diagram that shows the configuration of a control device according to the embodiment of the present invention;

FIGS. 3A and 3B show diagrams for explaining an output torque characteristic of the electric vehicle drive system according to the embodiment of the present invention;

FIG. 4 is an explanatory diagram of a control for clutches and rotating electric machines according to the embodiment of the present invention;

FIGS. 5A and 5B show a skeleton diagram and an output torque characteristic of the electric vehicle drive system according to another embodiment of the present invention;

FIGS. 6A and 6B show a skeleton diagram and an output torque characteristic of the electric vehicle drive system according to another embodiment of the present invention; and

FIGS. 7A and 7B show a skeleton diagram and an output torque characteristic of the electric vehicle drive system according to another embodiment of the present invention.

### DETAILED DESCRIPTION OF THE EMBODIMENTS

### First Embodiment

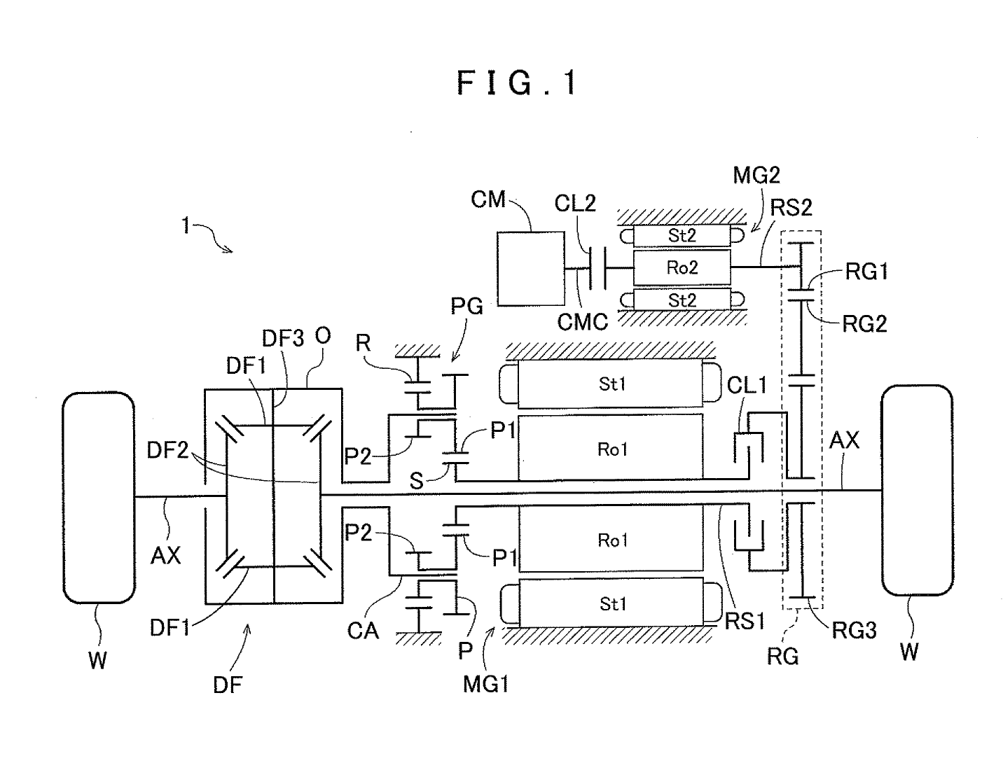

An embodiment of an electric vehicle drive system 1 according to the present invention will be described with reference to the drawings. FIG. 1 is a schematic diagram that shows the overall configuration of the electric vehicle drive system 1 according to the present embodiment. As shown in the figure, the electric vehicle drive system 1 according to the present embodiment is a drive system including an output shaft O that is drive-coupled to wheels W; and a compressor connection shaft CMC that is coupled to a compressor CM for an air conditioner, wherein a drive power to be transmitted to the output shaft O and the compressor connection member CMC is generated by rotating electric machines MG1, MG2.

Specifically, the electric vehicle drive system 1 includes a wheel-driving rotating electric machine MG1 that has a rotor shaft RS1 drive-coupled to the output shaft O; and an air-conditioner rotating electric machine MG2 that has a rotor shaft RS2 drive-coupled to the compressor connection shaft CMC through a second clutch CL2. Note that the output shaft O corresponds to an “output member” of the present invention, and the compressor connection shaft CMC corresponds to a “compressor connection member” of the present application.

In the configuration described above, as a characteristic of the electric vehicle drive system 1, the rotor shaft RS2 of the air-conditioner rotating electric machine is drive-coupled to the rotor shaft RS1 of the wheel-driving rotating electric machine through a first clutch CL1.

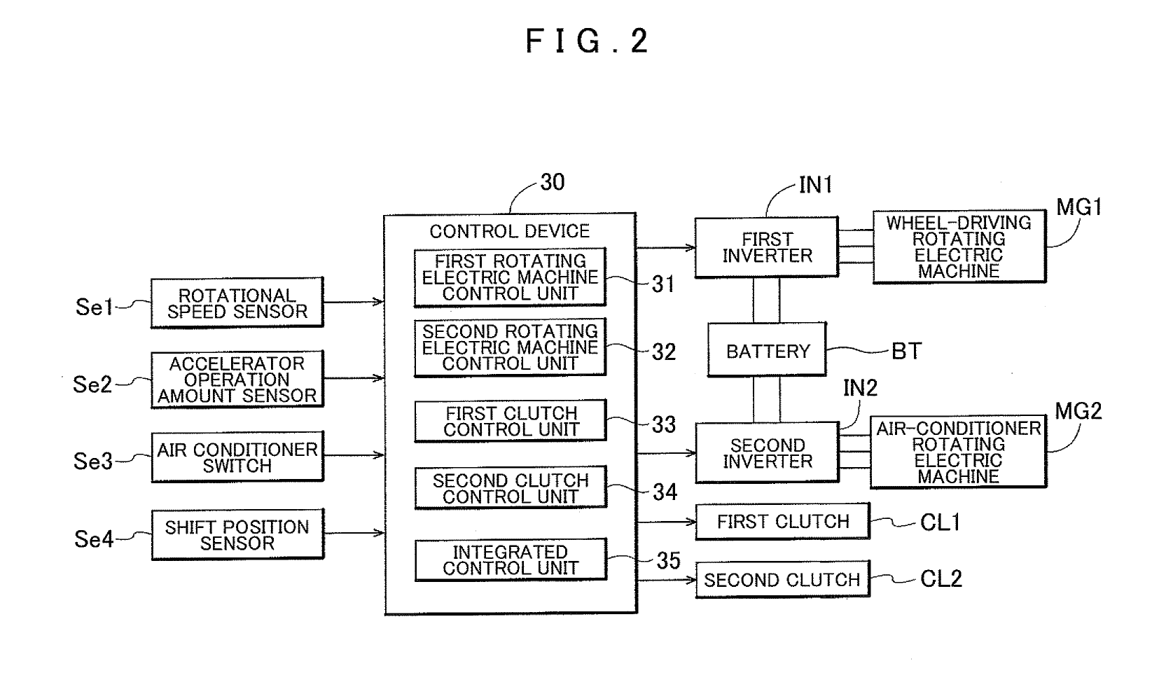

In addition, as shown in FIG. 2, the electric vehicle drive system 1 further includes a control device 30 that controls the first clutch CL1, the second clutch CL2, the wheel-driving rotating electric machine MG1, and the air-conditioner rotating electric machine MG2.

The electric vehicle drive system 1 according to the present embodiment will be described in detail below.

### 1. Configuration of Electric Vehicle Drive System 1

### 1-1. Wheel-Driving Rotating Electric Machine MG1

As shown in FIG. 1, the wheel-driving rotating electric machine MG1 includes a stator St1 that is fixed to a non-rotating member; and a rotor Ro1 that is rotatably supported radially inward of the stator St1. The rotor shaft RS1 of the wheel-driving rotating electric machine and the output shaft O are drive-coupled such that the rotation of the rotor shaft RS1 of the wheel-driving rotating electric machine is reduced in speed by a planetary gear mechanism PG, and the reduced rotation is transmitted to the output shaft O.

The wheel-driving rotating electric machine MG1 is electrically connected to a battery BT, which serves as an electric storage device, through a first inverter IN1 that performs an AC-DC conversion (see FIG. 2). The wheel-driving rotating electric machine MG1 can function as a motor (electric motor) that receives a supply of electric power to generate motive power, and also function as a generator (electric generator) that receives a supply of motive power to generate electric power. That is, the wheel-driving rotating electric machine MG1 receives through the first inverter IN1 a supply of electric power from the battery BT for power running, and through the first inverter IN1 stores in the battery BT (charges the battery BT with) electric power generated by the rotational driving force transmitted from the wheels W. Note that the battery BT is only one example of the electric storage device; another electric storage device such as a capacitor may be used, or a plurality of various electric storage devices may be used in combination. In addition, the first inverter IN1 includes a plurality of switching elements for converting the DC electric power of the battery BT into AC electric power to drive the wheel-driving rotating electric machine MG1, and for converting the AC electric power generated by the wheel-driving rotating electric machine MG1 into DC electric power to charge the battery BT.

In the present embodiment, the rotor shaft RS1 of the wheel-driving rotating electric machine is drive-coupled to the output shaft O through the planetary gear mechanism PG that serves as a speed reducer. The output shaft O is further drive-coupled to two left and right axles AX through an output differential gear device DF, and the axles AX are respectively drive-coupled to the two left and right wheels W. Thus, the torque transmitted from the wheel-driving rotating electric machine MG1 to the rotor shaft RS1 is transmitted to the two left and right wheels W through the planetary gear mechanism PG, the output shaft O, the output differential gear device DF, and the axles AX. Note that, in the power transmission path from the wheel-driving rotating electric machine MG1 to the wheels W, a drive connection mechanism such as a clutch or a speed change device configured with a changeable speed ratio may be included in place of or in addition to the planetary gear mechanism PG.

Further, the rotor shaft RS1 of the wheel-driving rotating electric machine is drive-coupled to the compressor connection shaft CMC through the first clutch CL1, the rotor shaft RS2 of the air-conditioner rotating electric machine, and the second clutch CL2. Thus, the torque transmitted from the wheel-driving rotating electric machine MG1 to the rotor shaft RS1 is also transmitted to the compressor connection shaft CMC when the first clutch CL1 and the second clutch CL2 are engaged.

### 1-2. Planetary Gear Mechanism PG

In the present embodiment, as shown in FIG. 1, the planetary gear mechanism PG is a single-pinion type of planetary gear mechanism that is coaxially disposed with the rotor shaft RS1 of the wheel-driving rotating electric machine, and includes a two-stage pinion gear P. Specifically, the planetary gear mechanism PG includes three rotation elements: a carrier CA that supports a plurality of pinion gears P; and a sun gear S and a ring gear R that each mesh with a pinion gear P. Here, the two-stage pinion gear P includes a first gear P1 and a second gear P2 with a smaller diameter than the first gear P1. The pinion gear P is configured so as to rotate together with the carrier CA, with the carrier CA corresponding to the rotation center axis of the pinion gear P. The first gear P1 meshes with the sun gear S, and the second gear P2 meshes with the ring gear R. The sun gear S is drive-coupled to the rotor shaft RS1 of the wheel-driving rotating electric machine so as to rotate together with the rotor shaft RS1. The carrier CA is drive-coupled to the output shaft O so as to rotate together with the output shaft O. The ring gear R is fixed to a non-rotating member such as a case that is fixed to the vehicle body.

Thus, the planetary gear mechanism PG functions as a speed reducer that reduces the rotational speed of the rotor shaft RS1 of the wheel-driving rotating electric machine by a predetermined speed ratio, and transmits the reduced rotational speed to the output shaft O. At such time, since the two-stage pinion gear P is provided, the reduction ratio of the planetary gear mechanism PG is set relatively large.

### 1-3. Output Differential Gear Device DF

The output differential gear device DF is a differential gear mechanism that uses a plurality of mutually meshing bevel gears. The output differential gear device DF distributes the rotation and the torque transmitted to the output shaft O, and transmits both to the two left and right wheels W through the axles AX.

In the present embodiment, the output differential gear device DF includes pinion gears DF1 that are each formed from a pair of bevel gears, and the pinion gears DF1 are coupled to the output shaft O. Here, the pinion gear DF1 is rotatable around a rotation support shaft DF3 that is coupled to the output shaft O. The rotation support shaft DF3 is disposed perpendicular to the rotation center axis of the output shaft O, and configured so as to rotate together with the output shaft O. That is, each pinion gear DF1 is configured to rotate together with the output shaft O, and rotatable around the rotation support shaft DF3 that rotates together with the output shaft O.

The output differential gear device DF also includes side gears DF2 that are each formed from a pair of bevel gears that respectively mesh with the pinion gears DF1. The rotation shafts of the side gears DF2 are respectively coupled with the right axle AX and the left axle AX. The rotation of the output shaft O rotates the pinion gears DF1, which rotates the side gears DF2 and the axles AX, thus rotating and driving the wheels W.

### 1-4. Air-Conditioner Rotating Electric Machine MG2

The air-conditioner rotating electric machine MG2 includes a stator St2 that is fixed to a non-rotating member; and a rotor Ro2 that is rotatably supported radially inward of the stator St2. The rotor shaft RS2 of the air-conditioner rotating electric machine is drive-coupled to the compressor connection shaft CMC through the second clutch CL2.

The air-conditioner rotating electric machine MG2 is electrically connected to the battery BT, which serves as an electric storage device, through a second inverter IN2 that performs an AC-DC conversion (see FIG. 2). The air-conditioner rotating electric machine MG2 can function as a motor (electric motor) that receives a supply of electric power to generate motive power. That is, the air-conditioner rotating electric machine MG2 receives through the second inverter IN2 a supply of electric power from the battery BT for power running.

Note that the maximum output of the air-conditioner rotating electric machine MG2 is set smaller than the maximum output of the wheel-driving rotating electric machine MG1. Here, the rotating electric machine output indicates power (W). In addition to functioning as a motor, the air-conditioner rotating electric machine MG2 may also function as a generator (electric generator) that receives a supply of motive power to generate electric power. That is, the air-conditioner rotating electric machine MG2 may be configured so as to, through the second inverter IN2, store in the battery BT (charge the battery BT with) electric power generated by the rotational driving force transmitted from the wheels W in (charge) the battery BT.

The torque transmitted from the air-conditioner rotating electric machine MG2 to the rotor shaft RS2 is transmitted to the compressor connection shaft CMC when the second clutch CL2 is engaged.

The rotor shaft RS2 of the air-conditioner rotating electric machine is drive-coupled to the rotor shaft RS1 of the wheel-driving rotating electric machine MG1 through the first clutch CL1. Since the rotor shaft RS1 of the wheel-driving rotating electric machine is drive-coupled to the output shaft O, the rotor shaft RS2 of the air-conditioner rotating electric machine is drive-coupled to the output shaft O through the first clutch CL1 and the rotor shaft RS1 of the wheel-driving rotating electric machine. Thus, the torque transmitted from the air-conditioner rotating electric machine to the rotor shaft RS2 is also transmitted to the output shaft O when the first clutch CL1 is engaged.

### 1-5. First Clutch CL1

The first clutch CL1 is an engagement device that selectively drive-couples and separates the rotor shaft RS2 of the air-conditioner rotating electric machine and the rotor shaft RS1 of the wheel-driving rotating electric machine. In the present embodiment, an input-side member of the first clutch CL1 is drive-coupled to the rotor shaft RS2 of the air-conditioner rotating electric machine through a power transmission mechanism RG, and an output-side member of the first clutch CL1 is drive-coupled to the rotor shaft RS1 of the wheel-driving rotating electric machine. The input-side member and the output-side member of the first clutch CL1 are selectively engaged with and disengaged from each other. In the present embodiment, the first clutch CL1 is an electromagnetic clutch. Here, the electromagnetic clutch is a device that performs clutch engagement and disengagement using an electromagnetic force generated by electromagnets. Note that, as the first clutch CL1, a hydraulic clutch that performs clutch engagement and disengagement using a hydraulic pressure, an electric clutch that performs clutch engagement and disengagement using the drive power of a servo motor, or other clutch may be used.

### 1-6. Power Transmission Mechanism RG

The power transmission mechanism RG is a power transmission mechanism that drive-couples the rotor shaft RS2 of the air-conditioner rotating electric machine and the rotor shaft RS1 of the wheel-driving rotating electric machine by a predetermined speed ratio. That is, the power transmission mechanism RG changes, by the predetermined speed ratio, the rotational speed and converts the torque of the rotor shaft RS2 of the air-conditioner rotating electric machine, and transmits the changed rotational speed and the converted torque to the rotor shaft RS1 of the wheel-driving rotating electric machine. Here, the speed ratio is a ratio of the rotational speed of the rotor shaft RS1 of the wheel-driving rotating electric machine to the rotational speed of the rotor shaft RS2 of the air-conditioner rotating electric machine. The speed ratio is a value that is obtained by dividing the rotational speed of the rotor shaft RS2 by the rotational speed of the rotor shaft RS1. In other words, the value obtained by dividing the rotational speed of the rotor shaft RS2 by the speed ratio equals the rotational speed of the rotor shaft RS1. In addition, a torque that multiplies the torque transmitted from the air-conditioner rotating electric machine MG2 to the rotor shaft RS2 by the speed ratio equals the torque transmitted to the rotor shaft RS1.

In the present embodiment, the power transmission mechanism RG is a speed reducer and the speed ratio thereof is a value greater than one. Moreover, in the present embodiment, the power transmission mechanism RG is configured from a gear mechanism. The power transmission mechanism RG includes a first gear RG1 that is drive-coupled to the rotor shaft RS2 of the air-conditioner rotating electric machine; a third gear RG3 that has a larger diameter than the first gear RG1 and is drive-coupled to the rotor shaft RS1 of the wheel-driving rotating electric machine through the first clutch CL1; and a second gear RG2 that meshes with the first gear RG1 and the third gear RG3, and is drive-coupled therebetween.

### 1-7. Second Clutch CL2

The second clutch CL2 is an engagement device that selectively drive-couples and separates the rotor shaft RS2 of the air-conditioner rotating electric machine and the compressor connection shaft CMC. In the present embodiment, an input-side member of the second clutch CL2 is drive-coupled to the rotor shaft RS2 of the air-conditioner rotating electric machine, and an output-side member of the second clutch CL2 is drive-coupled to the compressor connection shaft CMC. The input-side member and the output-side member of the second clutch CL2 are selectively engaged with and disengaged from each other. In the present embodiment, the second clutch CL2 is an electromagnetic clutch. Note that, as the second clutch CL2, a hydraulic clutch, an electric clutch, or other clutch may be used.

### 1-8. Compressor CM

The vehicle includes an air conditioner for adjusting the temperature and humidity inside the vehicle cabin. The compressor CM is a device that compresses a heating medium used by the air conditioner, and driven by external rotational drive power. To be more precise, a rotary compressor may be used as the compressor CM, wherein the rotary compressor includes therein a stator; and a rotor that is eccentrically-disposed with the stator and embedded with a plurality of slidable vanes. In the rotary compressor, the rotation of the rotor within the stator causes the volume of air as defined by two adjacent vanes, the rotor, and the stator to contract, which compresses the heating medium. The compressor connection shaft CMC coupled to the rotor of the compressor CM is configured so as to be drive-coupled to the rotor shaft RS2 of the air-conditioner rotating electric machine through the second clutch CL2. The rotation of the rotor shaft RS2 of the air-conditioner rotating electric machine can thus be transmitted to the rotor of the compressor CM through the second clutch CL2 to rotate and drive the compressor connection shaft CMC.

### 2. Configuration of Control Device 30

Next, the configuration of the control device 30 that controls the first clutch CL1, the second clutch CL2, the wheel-driving rotating electric machine MG1, and the air-conditioner rotating electric machine MG2 will be described.

The control device 30 has as its core member a computation processing device such as a CPU, and is configured with storage devices such as a random access memory (RAM) from which the computation processing device can read data and write data to, and a read only memory (ROM) from which the computation processing device can read data. Functional portions 31 to 35 of the control device 30 as shown in FIG. 2 are each configured from software (a program) stored in the ROM or the like of the control device 30, hardware such as a computation circuit separately provided, or both software and hardware.

As shown in FIG. 2, the electric vehicle drive system 1 includes sensors Se1 to Se4, and electrical signals output from each sensor are input to the control device 30. The control device 30 calculates the detection information of each sensor based on the input electrical signals.

A rotational speed sensor Se1 is a sensor that detects the rotational speed of the output shaft O. Since the rotational speed of the output shaft O is proportional to the vehicle speed, the control device 30 also calculates the vehicle speed from the input signal of the rotational speed sensor Se1.

An accelerator operation amount sensor Se2 is a sensor that detects the accelerator operation amount by detecting an amount that an accelerator pedal is operated by the driver.

An air conditioner switch Se3 is a switch by which the driver can manipulate the operation state of the air conditioner. Information on the switch position of the air conditioner switch Se3 is input to the control device 30.

A shift position sensor Se4 is a sensor that detects the selected position (shift position) of a shift lever. Based on information input from the shift position sensor Se4, the control device 30 detects which of the ranges of a drive range, a neutral range, a reverse drive range, a parking range, and other ranges is instructed by the driver.

As shown in FIG. 2, the control device 30 includes functional portions such as the following: a first rotating electric machine control unit 31, a second rotating electric machine control unit 32, a first clutch control unit 33, a second clutch control unit 34, and an integrated control unit 35. Each of these functional portions will be explained in more detail below.

### 2-1. First Rotating Electric Machine Control Unit 31

The first rotating electric machine control unit 31 is a functional portion that performs an operation control for the wheel-driving rotating electric machine MG1.

The first rotating electric machine control unit 31 performs a control that outputs a first required torque instructed by the integrated control unit 35 (described later) to the wheel-driving rotating electric machine MG1. Therefore, based on the rotational speed, the coil current, and the like of the wheel-driving rotating electric machine MG1, the first rotating electric machine control unit 31 drives and controls the first inverter IN1 by outputting signals for driving on and off a plurality of switching elements that is included in the first inverter IN1.

### 2-2. Second Rotating Electric Machine Control Unit 32

The second rotating electric machine control unit 32 is a functional portion that performs an operation control for the air-conditioner rotating electric machine MG2.

The second rotating electric machine control unit 32 performs a control that outputs a second required torque instructed by the integrated control unit 35 (described later) to the air-conditioner rotating electric machine MG2. Therefore, based on the rotational speed, the coil current, and the like of the air-conditioner rotating electric machine MG2, the second rotating electric machine control unit 32 drives and controls the second inverter IN2 by outputting signals for driving on and off a plurality of switching elements that is included in the second inverter IN2.

### 2-3. First Clutch Control Unit 33

The first clutch control unit 33 is a functional portion that performs an operation control for the first clutch CL1.

The first clutch control unit 33 controls the engagement and disengagement of the first clutch CL1 by outputting signals that engage or disengage the first clutch CL1 in response to an instruction from the integrated control unit 35 (described later) to engage or disengage the first clutch CL1. In the present embodiment, the first clutch control unit 33 is configured so as to output signals that turn on or off the conduction of electricity to the electromagnetic coils provided in the first clutch CL1.

### 2-4. Second Clutch Control Unit 34

The second clutch control unit 34 is a functional portion that performs an operation control for the second clutch CL2.

The second clutch control unit 34 controls the engagement and disengagement of the second clutch CL2 by outputting signals that engage or disengage the second clutch CL2 in response to an instruction from the integrated control unit 35 (described later) to engage or disengage the second clutch CL2. In the present embodiment, the second clutch control unit 34 is configured so as to output signals that turn on or off the conduction of electricity to the electromagnetic coils provided in the second clutch CL2.

### 2-5. Integrated Control Unit 35

The integrated control unit 35 is a functional portion that performs a control for the overall vehicle, which integrates the torque controls performed for the first clutch CL1, the second clutch CL2, the wheel-driving rotating electric machine MG1, the air-conditioner rotating electric machine MG2, and the like, as well as the clutch engagement controls and other controls.

The integrated control unit 35 calculates a vehicle required torque, which is a target drive power that is transmitted from a drive power source to the output shaft O, in accordance with the accelerator operation amount, the vehicle speed (rotational speed of the output shaft O), the charge amount of the battery, and the like. The integrated control unit 35 performs an integrated control by calculating a first required torque and a second required torque that are the output torques required of the rotating electric machines MG1, MG2, respectively, and specifying instructions to engage or disengage the first clutch CL1 and the second clutch CL2, and subsequently instructing these to the other functional portions 31 to 34.

### 2-5-1. Vehicle Output Torque Characteristic

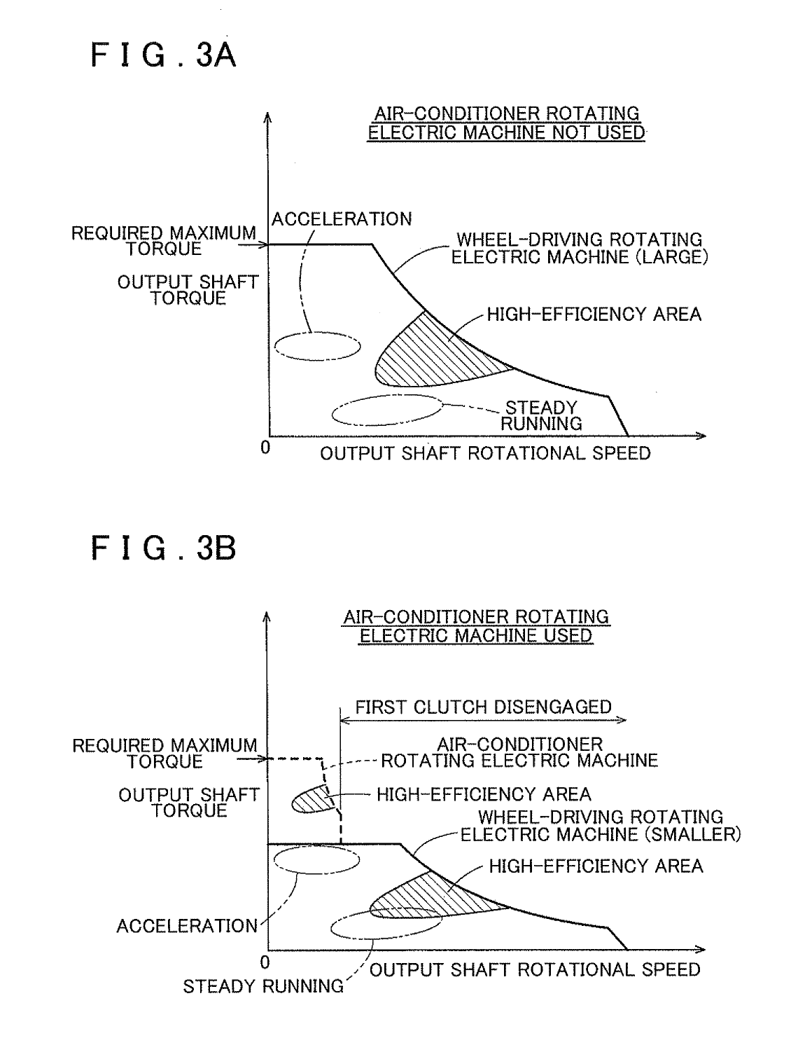

As shown in FIG. 3A, in an electric vehicle drive system that, unlike the present embodiment, does not use the drive power of the air-conditioner rotating electric machine MG2 as a drive power source of the vehicle, a sufficient vehicle output torque characteristic can be obtained using only the drive power of the wheel-driving rotating electric machine. That is, as shown in FIG. 3A, the wheel-driving rotating electric machine must be able to output any torque required over the range of rotational speeds of the output shaft O that corresponds to the practical range of vehicle speeds. In particular, the wheel-driving rotating electric machine is required to output a torque that enables the vehicle to climb a hill with a predetermined sharp incline (e.g., 18 degrees). Thus, as shown in FIG. 3A, the wheel-driving rotating electric machine must be able to output such a required maximum torque of the vehicle. In addition, the wheel-driving rotating electric machine is required to output a torque up to a predetermined maximum speed (e.g., 120 km/h) required of the vehicle. Accordingly, in an electric vehicle drive system that, unlike the present embodiment, does not utilize the air-conditioner rotating electric machine MG2, it is necessary to provide a high-performance wheel-driving rotating electric machine that has a large maximum output torque and a high maximum rotational speed.

As indicated by solid lines in FIGS. 3A and 3B, there is a high-efficiency area, wherein the conversion from electric power to torque is highly efficient, within the medium rotational speed and medium output torque area of the operation area of the rotating electric machine. Also, in the practical range of vehicle speeds, as indicated by dashed-two-dotted lines in FIGS. 3A and 3B, there is a high-frequency area for steady running on general roads within the medium rotational speed and low output torque area, and a high-frequency area for acceleration within the low rotational speed and medium output torque area. However, in the wheel-driving rotating electric machine of the electric vehicle drive system that, unlike the present embodiment, does not utilize the air-conditioner rotating electric machine MG2, the high-efficiency area does not coincide with the high-frequency area for steady running or the high-frequency area for acceleration. As a consequence, the use frequency of the high-efficiency area of the wheel-driving rotating electric machine lowers, and the electric power consumption rate cannot be improved.

Meanwhile, the electric vehicle drive system 1 according to the present embodiment is configured such that the air-conditioner rotating electric machine MG2 is used as a drive power source of the vehicle depending on engagement of the first clutch CL1. Therefore, the air-conditioner rotating electric machine MG2 can assist the wheel-driving rotating electric machine MG1. Thus, the combined output torque characteristic of the wheel-driving rotating electric machine MG1 and the air-conditioner rotating electric machine MG2 need only be capable of outputting any required torque over the practical range of rotational speeds of the output shaft O, and outputting the required maximum torque of the vehicle. Accordingly, compared to the electric vehicle drive system that does not utilize the air-conditioner rotating electric machine MG2, in the present embodiment as shown in FIG. 3B, a rotating electric machine with a characteristic of a lower maximum output torque than the required maximum torque of the vehicle is provided as the wheel-driving rotating electric machine MG1, which can reduce the size and cost of the wheel-driving rotating electric machine MG1.

In the present embodiment, the maximum output torque of the wheel-driving rotating electric machine MG1 is lower than the practical range of vehicle speeds. Therefore, the medium output torque area of the operation area of the wheel-driving rotating electric machine MG1 that corresponds to the high-efficiency area can approach and overlap with the low output torque area in the practical range of vehicle speeds. Thus, the use frequency of the high-efficiency area of the wheel-driving rotating electric machine MG1 can be increased, and the electric power consumption rate can be improved.

During acceleration, the acceleration torque is distributed and output to the wheel-driving rotating electric machine MG1 and the air-conditioner rotating electric machine MG2 such that the air-conditioner rotating electric machine MG2 can output torque in the high-efficiency area thereof, which can also improve the electric power consumption rate.

The present embodiment is configured such that controlling the engagement and disengagement of the first clutch CL1 selectively drive-couples and separates the rotor shaft RS2 of the air-conditioner rotating electric machine and the rotor shaft RS1 of the wheel-driving rotating electric machine.

Therefore, in the present embodiment, if the rotational speed of the output shaft O exceeds the usable range of rotational speeds of the air-conditioner rotating electric machine MG2, disengaging the first clutch CL1 ensures that the rotational speed of the air-conditioner rotating electric machine MG2 does not exceed the usable range of rotational speeds thereof. It is thus possible to prevent a failure caused by excessive rotation of the air-conditioner rotating electric machine MG2. There is also no need to match the usable range of rotational speeds of the air-conditioner rotating electric machine MG2 (based on the output shaft O) with the practical range of rotational speeds of the output shaft O, and the upper limit of the usable range of rotational speeds thereof can be set low.

Accordingly, a rotating electric machine whose usable range of rotational speeds has a low upper limit can be used as the air-conditioner rotating electric machine MG2, and the rotational speed of the air-conditioner rotating electric machine MG2 can be reduced by the power transmission mechanism (speed reducer) RG and transmitted to the output shaft O.

In the former case, a small rotating electric machine that is relatively inexpensive can be used as the air-conditioner rotating electric machine MG2.

In the latter case, by reducing the rotational speed of the air-conditioner rotating electric machine MG2 using the power transmission mechanism (speed reducer) RG and transmitting the reduced rotational speed to the output shaft O, the torque of the air-conditioner rotating electric machine MG2 can be increased and transmitted to the output shaft O. Moreover, since the rotational speed of the output shaft O that corresponds to the required maximum torque of the vehicle is a relatively low rotational speed, the rotational speed of the air-conditioner rotating electric machine MG2 can be decreased at a relatively large reduction ratio and the torque of the air-conditioner rotating electric machine MG2 that is transmitted to the output shaft O can be relatively increased.

By thus increasing the maximum output torque of the air-conditioner rotating electric machine MG2 based on the output shaft O, the maximum output torque of the wheel-driving rotating electric machine MG1 can be decreased, which further reduces the size and cost of the wheel-driving rotating electric machine MG1.

### 2-5-2. Control of Clutches and Rotating Electric Machines

In order to output a torque suited to the vehicle output torque characteristic as described above to the output shaft O, the integrated control unit 35 specifies instructions to engage or disengage the first clutch CL1 and the second clutch CL2, specifies the driving states of the rotating electric machines MG1, MG2, and instructs the functional portions 31 to 34.

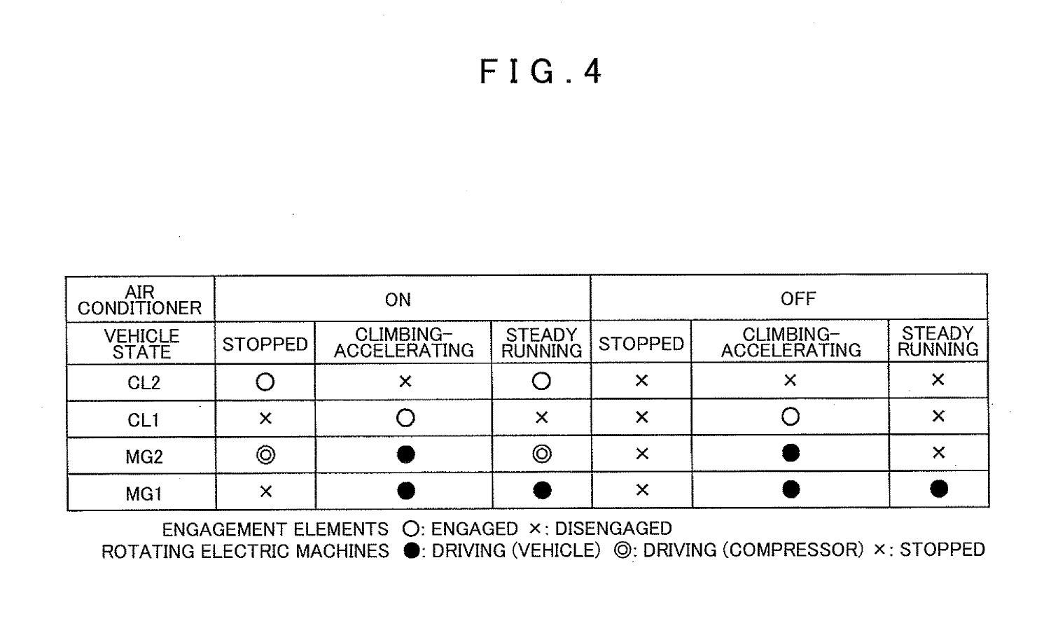

According to the present embodiment, as shown in FIG. 4, the integrated control unit 35 specifies instructions to engage or disengage the first clutch CL1 and the second clutch CL2, and specifies the driving states of the rotating electric machines MG1, MG2, based on whether there is an air conditioner operation request and based on the vehicle running state.

Regardless of whether there is an air conditioner operation request, if the vehicle required torque that is a torque required of the vehicle cannot be output by the wheel driving rotating electric machine MG1 alone, the integrated control unit 35 in the present embodiment controls the first clutch CL1 to an engaged state and controls the second clutch CL2 to a disengaged state, and outputs a positive torque to both the wheel-driving rotating electric machine MG1 and the air-conditioner rotating electric machine MG2. The control of the clutches and the rotating electric machines performed by the integrated control unit 35 will be described in further detail below.

The integrated control unit 35 specifies the vehicle running state based on the rotational speed of the output shaft O (vehicle speed), and the vehicle required torque that is calculated based on the accelerator operation amount, the vehicle speed, and the like as described above.

If the rotational speed of the output shaft O and the vehicle required torque are zero, the integrated control unit 35 determines that the vehicle running state corresponds to stopped.

If the vehicle required torque is equal to or greater than a predetermined climbing-accelerating threshold, the integrated control unit 35 determines that the vehicle running state corresponds to climbing-accelerating. Specifically, the climbing-accelerating threshold is set to a torque that requires assisting with the air-conditioner rotating electric machine MG2 because the wheel-driving rotating electric machine MG1 alone cannot output the vehicle required torque. Thus, if it is determined that the rotational speed of the output shaft O and the vehicle required torque fall within an area assisted by the air-conditioner rotating electric machine MG2, as shown by an area indicated by a broken line in FIG. 3B, the integrated control unit 35 determines that the vehicle running state corresponds to climbing-accelerating.

If it is determined that the vehicle running state does not correspond to stopped or climbing-accelerating, the integrated control unit 35 determines that the vehicle running state corresponds to steady running.

If it is determined based on the position of the air conditioner switch that the driver is requesting operation of the air-conditioner in a manner that requires driving the compressor CM, the integrated control unit 35 determines that there is an air conditioner operation request, and otherwise determines that there is no air conditioner operation request. In FIG. 4, “ON” indicates that there is an air conditioner operation request and “OFF” indicates that there is no air conditioner operation request.

### 2-5-2-1. Air Conditioner Operation Request Made

If there is an air conditioner operation request and the vehicle running state corresponds to stopped, the integrated control unit 35 controls the second clutch CL2 to an engaged state and controls the first clutch CL1 to a disengaged state. In addition, the integrated control unit 35 drive-couples the rotor shaft RS2 of the air-conditioner rotating electric machine and the compressor connection shaft CMC so that the drive power of the air-conditioner rotating electric machine MG2 can be transmitted to only the compressor CM. Next, the integrated control unit 35 calculates the second required torque so as to drive the air-conditioner rotating electric machine MG2 in order to drive the compressor CM. Note that, in this case, the integrated control unit 35 instructs the first rotating electric machine control unit 31 to stop the driving of the wheel-driving rotating electric machine MG1.

If there is an air conditioner operation request and the vehicle running state corresponds to steady running (if the vehicle request torque can be output by the wheel-driving rotating electric machine MG1 alone), the integrated control unit 35 controls the second clutch CL2 to an engaged state and controls the first clutch CL1 to a disengaged state. In addition, the integrated control unit 35 drive-couples the rotor shaft RS2 of the air-conditioner rotating electric machine and the compressor connection shaft CMC so that the drive power of the air-conditioner rotating electric machine MG2 can be transmitted to only the compressor CM. Next, the integrated control unit 35 calculates the second required torque so as to drive the air-conditioner rotating electric machine MG2 in order to drive the compressor CM. Based on the vehicle required torque, the integrated control unit 35 also calculates the first required torque.

If there is an air conditioner operation request and the vehicle running state corresponds to climbing-accelerating (if the vehicle request torque cannot be output by the wheel-driving rotating electric machine MG1 alone), the integrated control unit 35 controls the second clutch CL2 to a disengaged state and controls the first clutch CL1 to an engaged state. In addition, the integrated control unit 35 drive-couples the rotor shaft RS2 of the air-conditioner rotating electric machine and the output shaft O so that the drive power of the air-conditioner rotating electric machine MG2 can be transmitted to only the output shaft O.

Next, the integrated control unit 35 calculates the second required torque based on the vehicle required torque so as to drive the air-conditioner rotating electric machine MG2 in order to drive the vehicle. For example, the integrated control unit 35 may subtract the first required torque from the vehicle required torque and set the result as the second required torque. Note that the speed ratios of the planetary gear mechanism PG and the power transmission mechanism RG are considered at such time. Also, in this case, the first required torque may be set to the maximum output torque of the wheel-driving rotating electric machine MG1. Conversely, the maximum output torque of the air-conditioner rotating electric machine MG2 may be set as the second required torque, and the result of subtracting the second required torque from the vehicle required torque may be set as the first required torque.

Thus, if the wheel-driving rotating electric machine MG1 alone cannot output the vehicle required torque, regardless of an air conditioner operation request being made, the driving of the compressor CM by the air-conditioner rotating electric machine MG2 is stopped and the drive power of the air-conditioner rotating electric machine MG2 is used to drive the vehicle. Although the air conditioner in the vehicle cabin switches to a fan setting in such case, this does not pose a significant problem because the acceleration state that requires a large output torque lasts a relatively short time.

### 2-5-2-2. Air Conditioner Operation Request not Made

If there is no air conditioner operation request, the integrated control unit 35 controls the second clutch CL2 to a disengaged state.

If the vehicle running state corresponds to stopped, in addition to the second clutch CL2, the integrated control unit 35 also controls the first clutch CL1 to a disengaged state, and separates the rotor shaft RS2 of the air-conditioner rotating electric machine from the compressor connection shaft CMC and the output shaft O. Next, the integrated control unit 35 instructs the rotating electric machine control units 31, 32 to stop the driving of the rotating electric machines MG1, MG2.

If the vehicle running state corresponds to steady running, in addition to the second clutch CL2, the integrated control unit 35 also controls the first clutch CL1 to a disengaged state, and separates the rotor shaft RS2 of the air-conditioner rotating electric machine from the compressor connection shaft CMC and the output shaft O. Next, the integrated control unit 35 instructs the second rotating electric machine control unit 32 to stop the driving of the air-conditioner rotating electric machine MG2. Based on the vehicle required torque, the integrated control unit 35 also sets the first required torque.

If there is no air conditioner operation request and the vehicle running state corresponds to climbing-accelerating (if the vehicle request torque cannot be output by the wheel-driving rotating electric machine MG1 alone), the integrated control unit 35 controls the second clutch CL2 to a disengaged state and controls the first clutch CL1 to an engaged state. In addition, the integrated control unit 35 drive-couples the rotor shaft RS2 of the air-conditioner rotating electric machine and the output shaft O so that the drive power of the air-conditioner rotating electric machine MG2 can be transmitted to the output shaft O. Next, the integrated control unit 35 calculates the second required torque based on the vehicle required torque, as described above, so as to drive the air-conditioner rotating electric machine MG2 in order to drive the vehicle.

Thus, similar to when there is an air conditioner operation request as described above, if the wheel-driving rotating electric machine MG1 alone cannot output the vehicle required torque, regardless of no air conditioner operation request being made, the drive power of the air-conditioner rotating electric machine MG2 is used to drive the vehicle so that the vehicle required torque can be output.

### Other Embodiments

Other embodiments of the present invention will be explained next. It should be noted that the constitution of each embodiment described herein is not limited to being applied in an individual manner, and may be applied in combination with the constitution of other embodiments unless an inconsistency occurs.

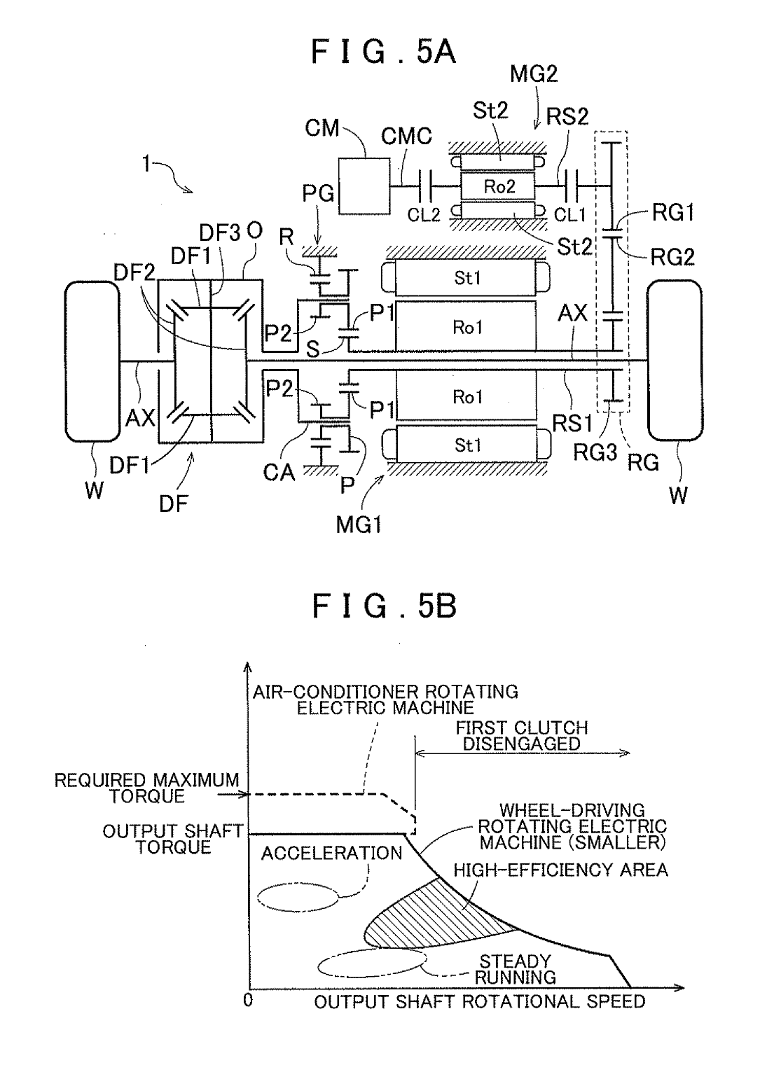

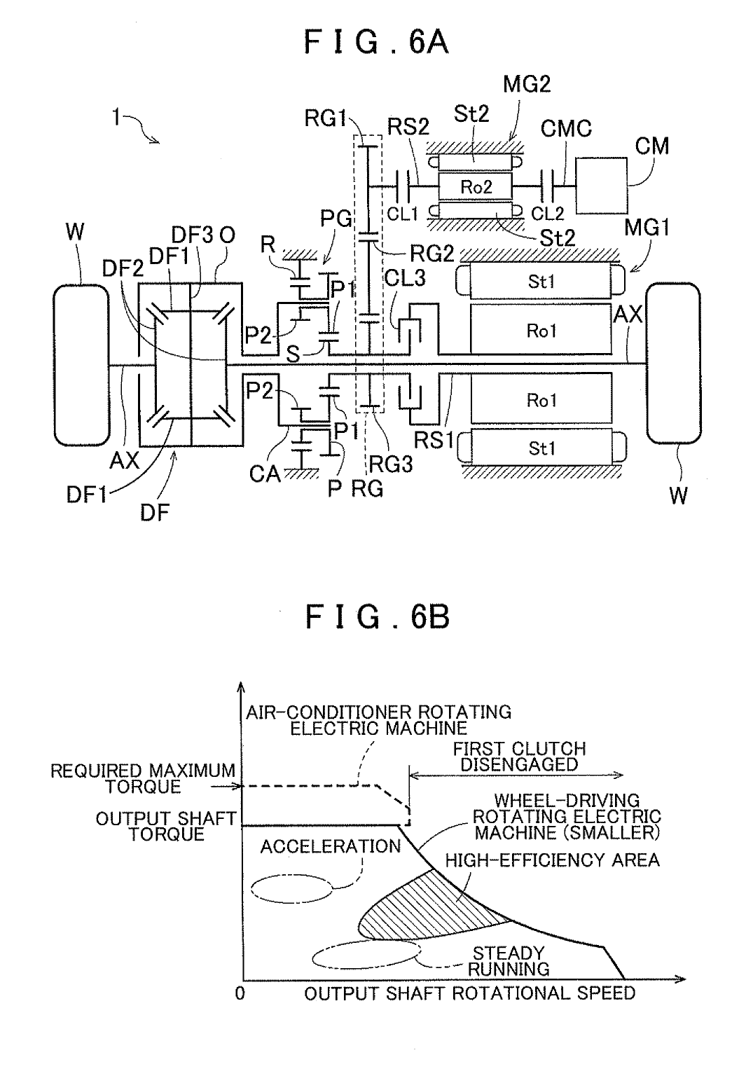

(1) In the embodiment described above, as an example, the first clutch CL1 is disposed between the rotor shaft RS1 of the wheel-driving rotating electric machine and the power transmission mechanism (speed reducer) RG as shown in FIG. 1. However, the embodiments of the present invention are not limited to this example. The first clutch CL1 may be disposed at any position, provided that the first clutch CL1 can selectively drive-couple and separate the rotor shaft RS2 of the air-conditioner rotating electric machine and the rotor shaft RS1 of the wheel-driving rotating electric machine. For example, as shown in FIGS. 5A and 6A, the first clutch CL1 may be disposed between the rotor shaft RS2 of the air-conditioner rotating electric machine and the power transmission mechanism RG.

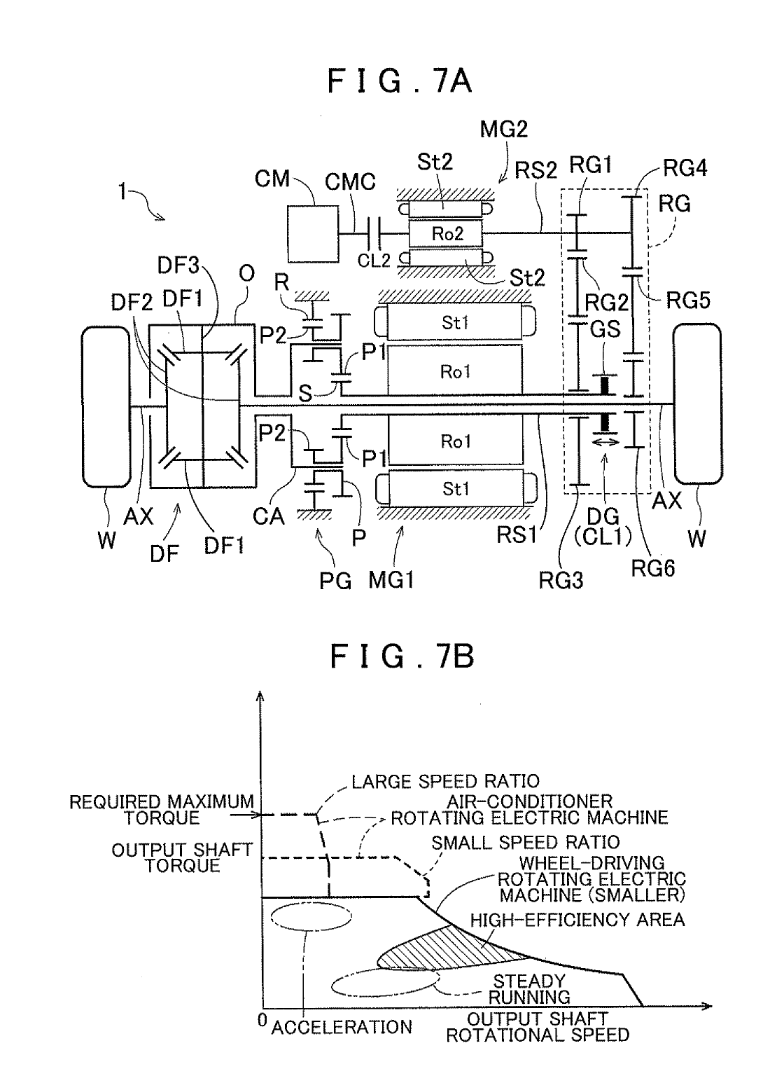

(2) In the embodiment described above, as an example, the power transmission mechanism RG is a speed reducer as shown in FIG. 1. However, the embodiments of the present invention are not limited to this example. The power transmission mechanism RG may be any power transmission mechanism, provided that the power transmission mechanism RG drive-couples the rotor shaft RS2 of the air-conditioner rotating electric machine and the rotor shaft RS1 of the wheel-driving rotating electric machine by a predetermined speed ratio. For example, as shown in FIGS. 5A and 6A, the power transmission mechanism RG may be a speed increaser with a speed ratio whose value is less than one. Also, as shown in FIG. 7A, the power transmission mechanism RG may be a speed change device configured with a changeable speed ratio.

Even if the power transmission mechanism RG is a speed increaser, the air-conditioner rotating electric machine MG2 can assist the wheel-driving rotating electric machine MG1 as shown in FIGS. 5B and 6B. In this case as well, a rotating electric machine with a characteristic of a lower maximum output torque than the required maximum torque of the vehicle is provided as the wheel-driving rotating electric machine MG1, which can reduce the size and cost of the wheel-driving rotating electric machine MG1.

Moreover, in this case as well, controlling the engagement and disengagement of the first clutch CL1 selectively drive-couples and separates the rotor shaft RS2 of the air-conditioner rotating electric machine and the rotor shaft RS1 of the wheel-driving rotating electric machine. Thus, if the rotational speed of the output shaft O exceeds the usable range of rotational speeds of the air-conditioner rotating electric machine MG2 when the power transmission mechanism RG is a speed increaser, disengaging the first clutch CL1 ensures that the rotational speed of the air-conditioner rotating electric machine MG2 does not exceed the usable range of rotational speeds thereof.

Even if a rotating electric machine whose usable range of rotational speeds has a relatively low upper limit is used as the air-conditioner rotating electric machine MG2, because the power transmission mechanism RG is a speed increaser, the rotational speed of the air-conditioner rotating electric machine MG2 can be increased up to the usable range of rotational speeds of the wheel-driving rotating electric machine MG1 as shown in FIGS. 5B and 6B. It is thus possible to reduce the rotational speed area of the output shaft O that cannot be assisted by the air-conditioner rotating electric machine MG2, and a smoother combined output torque characteristic of the wheel-driving rotating electric machine MG1 and the air-conditioner rotating electric machine MG2 can be achieved. In addition, an inexpensive and small rotating electric machine whose usable range of rotational speeds has a relatively low upper limit can be used as the air-conditioner rotating electric machine MG2.

If the power transmission mechanism RG is a transmission, as shown in FIG. 7B, the speed ratio is set large when the required maximum torque of the vehicle is needed, and the speed ratio is otherwise set small to reduce the rotational speed area of the output shaft O that cannot be assisted by the air-conditioner rotating electric machine MG2.

In the example shown in FIG. 7A, a transmission that can switch the speed ratio in two stages is used as the transmission. Also, in the example shown in FIG. 7A, the transmission is configured capable of switching between a first shift speed and a second shift speed with different speed ratios through a dog clutch DG.

Specifically, provided for the first shift speed are: the first gear RG1 that is coupled to the rotor shaft RS2 of the air-conditioner rotating electric machine; the third gear RG3 that is supported rotatable around the rotor shaft RS1 of the wheel-driving rotating electric machine; and the second gear RG2 that meshes with the first gear RG1 and the third gear RG3, and is drive-coupled therebetween. Provided for the second shift speed are: a fourth gear RG4 that is coupled to the rotor shaft RS2 of the air-conditioner rotating electric machine; a sixth gear RG6 that is rotatably supported and coaxial with the rotor shaft RS1 of the wheel-driving rotating electric machine; and a fifth gear RG5 that meshes with the fourth gear RG4 and the sixth gear RG6, and is drive-coupled therebetween.

The dog clutch DG is in spline engagement with the rotor shaft RS1 of the wheel-driving rotating electric machine so as to be movable in the axial direction. When a gear selector GS of the dog clutch DG moves in the axial direction on the rotor shaft RS1 toward the third gear RG3 side to couple with the third gear RG3 for the first shift speed, the third gear RG3 for the first shift speed drive-couples with the rotor shaft RS1 of the wheel-driving rotating electric machine to form the first shift speed in the transmission. When the gear selector GS of the dog clutch DG moves in the axial direction on the rotor shaft RS1 toward the sixth gear RG6 side to couple with the sixth gear RG6 for the second shift speed, the sixth gear RG6 for the second shift speed drive-couples with the rotor shaft RS1 of the wheel-driving rotating electric machine to form the second shift speed in the transmission. If the gear selector GS of the dog clutch DG is at an intermediate position between the third gear RG3 and the sixth gear RG6, a neutral state is achieved in which no shift speed is formed in the transmission. In such case, the rotor shaft RS2 of the air-conditioner rotating electric machine and the rotor shaft RS1 of the wheel-driving rotating electric machine are separated. Thus, the dog clutch DG also functions as the first clutch CL1 that selectively drive-couples and separates the rotor shaft RS2 of the air-conditioner rotating electric machine and the rotor shaft RS1 of the wheel-driving rotating electric machine.

Note that the dog clutch DG is configured so as to move in the axial direction by an electromagnetic force, the drive power of a servo motor, or the like, and controlled using the same method as that used by the control device 30 for the first clutch control unit 33.

(3) In the embodiment described above, as an example, the power transmission mechanism RG is a gear mechanism configured from a plurality of gears. However, the embodiments of the present invention are not limited to this example. The power transmission mechanism RG may be any gear mechanism, provided that the power transmission mechanism RG drive-couples the rotor shaft RS2 of the air-conditioner rotating electric machine and the rotor shaft RS1 of the wheel-driving rotating electric machine by a predetermined speed ratio. For example, the power transmission mechanism RG may be a mechanism configured by a belt and a plurality of pulleys, or a mechanism configured by a chain and a plurality of gears. Moreover, the power transmission mechanism RG may have a speed ratio of one.

(4) In the embodiment described above, as an example, the power transmission mechanism RG is drive-coupled to the rotor shaft RS1 of the wheel-driving rotating electric machine on a side opposite from a side on which the output shaft O is drive-coupled to the rotor Ro1 as shown in FIG. 1. However, the embodiments of the present invention are not limited to this example. The power transmission mechanism RG may be drive-coupled to the rotor shaft RS1 of the wheel-driving rotating electric machine on the same side where the output shaft O is drive-coupled to the rotor Ro1 as shown in FIG. 6A.

(5) In the embodiment described above, as an example, the rotor shaft RS1 of the wheel-driving rotating electric machine is drive-coupled to the output shaft O through the planetary gear mechanism PG. However, the embodiments of the present invention are not limited to this example. The rotor shaft RS1 of the wheel-driving rotating electric machine may be configured as directly drive-coupled to the output shaft O, or drive-coupled to the output shaft O through a power transmission mechanism other than the planetary gear mechanism PG such as the transmission or the speed reducer.

(6) In the embodiment described above, as an example, the rotor shaft RS1 of the wheel-driving rotating electric machine is drive-coupled to the output shaft O. However, the embodiments of the present invention are not limited to this example. The rotor shaft RS1 of the wheel-driving rotating electric machine may be configured as drive-coupled to the output shaft O through a third clutch CL3 as shown in FIG. 6A. According to this configuration, if the wheel-driving rotating electric machine MG1 cannot output torque, the third clutch CL3 can be disengaged to cancel the drive-coupling between the rotor shaft RS1 and the output shaft O. It is thus possible to reduce the energy loss caused by rotation of the wheel-driving rotating electric machine MM. In particular, if the first clutch CL1 is engaged and only the drive power of the air-conditioner rotating electric machine MG2 drives the vehicle, disengaging the third clutch CL3 can reduce the energy loss caused by the rotation of the wheel-driving rotating electric machine MG1 and improve the efficiency of driving the vehicle using the air-conditioner rotating electric machine MG2.

(7) In the embodiment described above, as an example, the control device 30 controls the first clutch CL1 to a disengaged state and drives the vehicle using the wheel-driving rotating electric machine MG1 if the vehicle running state corresponds to steady running as shown in FIG. 4. However, the embodiments of the present invention are not limited to this example. The control device 30 may be configured so as to control the first clutch CL1 to an engaged state if the vehicle running state corresponds to steady running.

Specifically, if there is an air conditioner operation request, the second clutch CL2 is also controlled so as to engage. Therefore, the compressor CM and the vehicle may be driven by the drive power of the air-conditioner rotating electric machine MG2 and the wheel-driving rotating electric machine MG1. Alternatively, the output torque of the air-conditioner rotating electric machine MG2 may be controlled to zero, and the compressor CM and the vehicle may be driven by only the drive power of the wheel-driving rotating electric machine MG1.

Meanwhile, if there is no air conditioner operation request, the second clutch CL2 is also controlled so as to disengage. Therefore, the vehicle may be driven by the drive power of both the air-conditioner rotating electric machine MG2 and the wheel-driving rotating electric machine MG1. Alternatively, the drive power of the wheel-driving rotating electric machine MG1 may be controlled to zero, and the vehicle may be driven by only the drive power of the output torque of the air-conditioner rotating electric machine MG2.

In addition, the control device 30 may be configured to control the first clutch CL1 to an engaged state only if the rotational speed of the output shaft O falls within the low rotational speed area that corresponds to the operation area of the compressor CM or the air-conditioner rotating electric machine MG2.

The present invention is well suited for use as an electric vehicle drive system including an output member that is drive-coupled to a wheel; and a compressor connection member that is coupled to a compressor for an air conditioner, wherein a drive power to be transmitted to the output member and the compressor connection member is generated by a rotating electric machine.

What is claimed is:

1. An electric vehicle drive system including an output member that is drive-coupled to a wheel, and a compressor connection member that is coupled to a compressor for an air conditioner, wherein
a drive power to be transmitted to the output member and the compressor connection member is generated by a rotating electric machine, the electric vehicle drive system further comprising:
a wheel-driving rotating electric machine that has a rotor shaft drive-coupled to the output member; and
an air-conditioner rotating electric machine that has a rotor shaft drive-coupled to the compressor connection member through a second clutch, wherein
the rotor shaft of the air-conditioner rotating electric machine is drive-coupled to the rotor shaft of the wheel-driving rotating electric machine through a first clutch.

2. The electric vehicle drive system according to claim 1, wherein
the drive power to be transmitted to the output member and the compressor connection member is generated by only the wheel-driving rotating electric machine and the air-conditioner rotating electric machine.

3. The electric vehicle drive system according to claim 1, wherein
a maximum output of the air-conditioner rotating electric machine is smaller than a maximum output of the wheel-driving rotating electric machine.

4. The electric vehicle drive system according to claim 1, wherein
the rotor shaft of the air-conditioner rotating electric machine is drive-coupled to the rotor shaft of the wheel-driving rotating electric machine through a speed reducer.

5. The electric vehicle drive system according to claim 1, wherein
the rotor shaft of the wheel-driving rotating electric machine is drive-coupled to the output member through a third clutch.

6. The electric vehicle drive system according to claim 1, wherein
the rotor shaft of the air-conditioner rotating electric machine is drive-coupled to the rotor shaft of the wheel-driving rotating electric machine through a transmission with a changeable speed ratio.

7. The electric vehicle drive system according to claim 1, wherein
the rotor shaft of the air-conditioner rotating electric machine is drive-coupled to the output member through the rotor shaft of the wheel-driving rotating electric machine.

8. The electric vehicle drive system according to claim 1, further comprising:
a control device that controls the first clutch, the second clutch, the wheel-driving rotating electric machine, and the air-conditioner rotating electric machine, wherein
the control device, regardless of whether a request is made to operate the air conditioner, sets the first clutch to an engaged state and the second clutch to a disengaged state, and outputs a positive torque to both the wheel-driving rotating electric machine and the air-conditioner rotating electric machine if a vehicle required torque that is a torque required of a vehicle cannot be output by the wheel-driving rotating electric machine alone.

9. The electric vehicle drive system according to claim 2, wherein
a maximum output of the air-conditioner rotating electric machine is smaller than a maximum output of the wheel-driving rotating electric machine.

10. The electric vehicle drive system according to claim 9, wherein
the rotor shaft of the air-conditioner rotating electric machine is drive-coupled to the rotor shaft of the wheel-driving rotating electric machine through a speed reducer.

11. The electric vehicle drive system according to claim 10, wherein
the rotor shaft of the wheel-driving rotating electric machine is drive-coupled to the output member through a third clutch.

12. The electric vehicle drive system according to claim 11, wherein
the rotor shaft of the air-conditioner rotating electric machine is drive-coupled to the rotor shaft of the wheel-driving rotating electric machine through a transmission with a changeable speed ratio.

13. The electric vehicle drive system according to claim 12, wherein
the rotor shaft of the air-conditioner rotating electric machine is drive-coupled to the output member through the rotor shaft of the wheel-driving rotating electric machine.

14. The electric vehicle drive system according to claim 13, further comprising:
a control device that controls the first clutch, the second clutch, the wheel-driving rotating electric machine, and the air-conditioner rotating electric machine, wherein
the control device, regardless of whether a request is made to operate the air conditioner, sets the first clutch to an engaged state and the second clutch to a disengaged state, and outputs a positive torque to both the wheel-driving rotating electric machine and the air-conditioner rotating electric machine if a vehicle required torque that is a torque required of a vehicle cannot be output by the wheel-driving rotating electric machine alone.

15. The electric vehicle drive system according to claim 2, wherein
the rotor shaft of the air-conditioner rotating electric machine is drive-coupled to the rotor shaft of the wheel-driving rotating electric machine through a speed reducer.

16. The electric vehicle drive system according to claim 2, wherein
the rotor shaft of the wheel-driving rotating electric machine is drive-coupled to the output member through a third clutch.

17. The electric vehicle drive system according to claim 2, wherein
the rotor shaft of the air-conditioner rotating electric machine is drive-coupled to the rotor shaft of the wheel-driving rotating electric machine through a transmission with a changeable speed ratio.

18. The electric vehicle drive system according to claim 3, wherein
the rotor shaft of the air-conditioner rotating electric machine is drive-coupled to the rotor shaft of the wheel-driving rotating electric machine through a speed reducer.

19. The electric vehicle drive system according to claim 3, wherein
the rotor shaft of the wheel-driving rotating electric machine is drive-coupled to the output member through a third clutch.

20. The electric vehicle drive system according to claim 3, wherein
the rotor shaft of the air-conditioner rotating electric machine is drive-coupled to the rotor shaft of the wheel-driving rotating electric machine through a transmission with a changeable speed ratio.
